(19) United States
(12) Patent Application Publication
(10) Pub. No.: US 2026/0179815 A1
(43) Pub. Date: Jun. 25, 2026

(54) MAGNETIC-FIELD-SENSITIVE ASSEMBLY, INDUCTIVE COMPONENT, METHOD AND USE

(71) Applicant: Magnetec GmbH, Hanau (DE)

(72) Inventor: Thomas WENTZLIK, Frankfurt Main (DE)

(21) Appl. No.: 19/128,656

(22) PCT Filed: Oct. 23, 2023
(86) PCT No.: PCT/EP2023/079440

§ 371 Date: May 9, 2025

(30) Foreign Application Priority Data
Nov. 14, 2022 (DE) 10 2022 130 007.2

(51) Int. Cl. H01F 1/147; H01F 7/02; H01F 17/04

(52) U.S. Cl. CPC H01F 1/14708; H01F 7/0263; H01F 17/04

(57) ABSTRACT

A magnetic field-sensitive assembly includes a ring-shaped magnetic field-sensitive component and at least one web-shaped magnetic field-sensitive component accommodated in a housing, wherein the ring-shaped magnetic field-sensitive component includes a through opening and an inner cylindrical surface and an outer cylindrical surface, wherein the housing includes at least a first penetration extending through the housing within the through opening of the ring-shaped magnetic field sensitive component, and the magnetic field-sensitive assembly further includes at least one clamping means which is set up to clamp the web-shaped magnetic field-sensitive component within the ring-shaped magnetic field-sensitive component. Further, an inductive component, a method of manufacturing a magnetic field-sensitive assembly and the use of a magnetic field-sensitive assembly are provided.

The invention relates to a magnetic field-sensitive assembly, an inductive component, a method and a use.

Inductive components, in particular chokes, are used for a variety of electronic and/or electrical applications, preferably for limiting currents in electrical lines, for intermediate storage of energy in the form of their magnetic field, for impedance matching and/or for filtering an electronic and/or electrical signal.

When using an inductive component as an interference suppression choke, direct current and low-frequency currents should not be affected by the choke, or only slightly, while high-frequency should be effectively reduced by utilizing the impedance of the inductance.

Connecting cables in DC networks usually have a forward and a return line. The interference currents that occur in such lines can be divided into common mode interference currents and differential mode interference currents. Common-mode interference currents are interference currents on the connecting lines between electrical components or electrical components that occur with the same current direction on both the outgoing and return lines. In contrast, differential mode interference currents propagate in opposite directions on connecting cables.

Until now, it has been necessary to use separate components, in particular chokes, to filter or attenuate differential-mode interference currents and common-mode interference currents in corresponding DC networks. Although this has generally proved successful, the fact that a corresponding arrangement is relatively complex and requires a relatively large installation space is considered a disadvantage in some cases.

Especially for mobile applications and/or other space-sensitive and cost-sensitive applications, there is a desire to design the required tasks as space-saving, cost-effective and robust as possible. Furthermore, a good filter effect for high-frequency interference currents, a temperature that is as constant as possible and good adaptability to the designated application are also desirable.

The invention is based on the task of providing an improvement or an alternative to the prior art.

According to a first aspect of the invention, this task is solved by a magnetic field-sensitive assembly comprising:
a ring-shaped magnetic field-sensitive component and at least one web-shaped magnetic field-sensitive component accommodated in a housing;
wherein the ring-shaped magnetic field-sensitive component has a longitudinal extension direction and a centrally arranged through-opening extending in the longitudinal extension direction, wherein the through-opening is formed in cross-section as an oval with two axes of symmetry;
wherein the ring-shaped magnetic field-sensitive component has an inner cylindrical surface and an outer cylindrical surface;
wherein the web-shaped magnetic field-sensitive component is cuboidal in shape, has a base surface and a top surface and is arranged within the through-opening, the base surface and the top surface being arranged in correspondence with the inner cylindrical surface;
wherein the housing has at least a first penetration extending through the housing within the through-opening of the ring-shaped magnetic field sensitive component;
the magnetic field-sensitive assembly comprises at least one clamping means which is adapted to clamp the web-shaped magnetic field-sensitive component within the ring-shaped magnetic field-sensitive component.

The invention is based on the fundamental consideration of creating a magnetic field-sensitive assembly that can effectively filter or attenuate both common-mode interference currents and differential-mode interference currents.

The ring-shaped magnetic field-sensitive component is optimized in particular for attenuating or cancelling common-mode interference currents. Cancellation is preferably achieved by superimposing the common-mode interference currents in the magnetic flux. As the electrical lines are usually routed around the ring-shaped magnetic field-sensitive component in opposite areas or through one penetration each, the common-mode interference currents each cause a magnetic flux in the ring-shaped component; the magnetic fluxes can overlap, which cancels them out. As a result, the common-mode interference currents are filtered by the magnetic field-sensitive assembly.

In contrast, the web-shaped magnetic field-sensitive component is primarily used to attenuate the differential-mode interference currents. For this purpose, the web-shaped magnetic field-sensitive component preferably has a significantly lower permeability than the ring-shaped magnetic field-sensitive component, but a significantly higher coercive field strength.

The assembly according to the invention can efficiently attenuate or filter out both common-mode interference currents and differential-mode interference currents. This means that it is no longer necessary to provide separate assemblies, preferably designed as chokes, for both types of interference currents. This allows an electrical system to be optimized in terms of installation space, weight and costs.

By clamping the web-shaped magnetic field-sensitive component inside the ring-shaped magnetic field-sensitive component, it is achieved that the two components are in contact with each other, particularly over a flat surface. This prevents an air gap between the components, which can have a negative effect on the properties of the magnetic field-sensitive assembly. By clamping the web-shaped magnetic field-sensitive component to the ring-shaped magnetic field-sensitive component in this way, manufacturing tolerances can also be compensated for, particularly in the case of the ring-shaped component. In addition, the assembly of the magnetic field-sensitive component is simplified, as the web-shaped component can be inserted into the through-opening of the ring-shaped component with clearance before it is clamped. The fact that there is no longer a gap between the web-shaped magnetic field-sensitive component and the ring-shaped magnetic field-sensitive component also results in defined magnetic properties of the assembly and thus a high reproducibility of the attenuating effect. At the same time, changes in length as a result of temperature fluctuations during operation are also compensated for.

The following terms are used to explain this:

First of all, it should be expressly pointed out that, in the context of the present patent application, indefinite articles and numerical indications such as “one”, “two” etc. are generally to be understood as “at least” indications, i.e. as “at least one . . . ”, “at least two . . . ” etc., unless it is expressly apparent from the respective context or it is obvious or technically mandatory for the person skilled in the art that only “exactly one . . . ”, “exactly two . . . ” etc. can be meant there.

In the context of the present patent application, the expression “in particular” is always to be understood as introducing an optional, preferred feature. The expression is not to be understood as “and indeed” and not as “namely”.

The term “magnetic field-sensitive component” refers to a component, in particular a ferromagnetic component, which reacts to a magnetic field by changing at least one state variable of the component. An inductive component that can be used for electrical and/or electronic applications can be produced from a magnetic field-sensitive component together with electrically conductive conductors.

An “oval” is a flat round convex figure. An oval includes circles and ellipses as special cases, whereby any oval, unlike these, does not have to have an axis of symmetry. In particular, an oval is a closed twice continuously differentiable convex curve in the plane.

If the curve of an oval is arranged as a mirror image on both sides of an imaginary line, the oval has an axis of symmetry. If the curve of an oval is arranged as a mirror image on both sides of two non-coinciding imaginary lines, the oval has two axes of symmetry. In particular, a circle and an ellipse are each an oval with two axes of symmetry.

The ring-shaped magnetic field-sensitive component can be circular. In this case, the through opening has a circular cross-section. Alternatively, the ring-shaped magnetic field-sensitive component can also comprise two opposing rectilinear sections that run parallel to each other and are connected to each other by semicircular arcs. Preferably, the ring-shaped magnetic field-sensitive component has an at least essentially constant, in particular rectangular, cross-section over its entire circumference.

The ring-shaped magnetic field-sensitive component can extend in the longitudinal extension direction over a length of at least 15 mm, in particular at least 20 mm, preferably at least 25 mm, particularly preferably at least 35 mm, and/or at most 100 mm, in particular at most 75 mm, preferably at most 60 mm, particularly preferably at most 40 mm. The opening width of the through-opening, in particular in a section of the through-opening in which the web-shaped magnetic field-sensitive component is located, can be at least 8 mm, in particular at least 12 mm, preferably at least 15 mm, and/or at most 50 mm, in particular at most 40 mm, preferably at most 30 mm. The opening width is particularly preferably 20 mm.

Such dimensions have proven to be advantageous for the attenuation properties of the magnetic field-sensitive assembly, particularly for filtering common mode interference currents. The dimensions can be adapted to the specific application.

A “through-opening” is understood to be a free cross-section that is formed in the inner area of the magnetic field-sensitive component. Preferably, the through-opening extends in the direction of an axial extension of the magnetic field-sensitive component.

A “housing” is understood to be a component which electrically and/or electronically insulates at least the ring-shaped magnetic field-sensitive component and/or the web-shaped magnetic field-sensitive component from its environment. Furthermore, the housing can be designed to accommodate at least the ring-shaped magnetic field-sensitive component and/or the web-shaped magnetic field-sensitive component and to enable the accommodated components to be arranged relative to one another. In other words, the housing can influence the relative position of the ring-shaped magnetic field-sensitive component and/or the web-shaped magnetic field-sensitive component.

The housing can be made of a plastic, in particular a thermoplastic and/or a thermosetting plastic, or have such a material.

Advantageously, the housing can be or be manufactured from an injection molding process and/or a thermoforming process and/or a PUR-RIM process and/or another plastic manufacturing process.

The housing can at least partially enclose the ring-shaped magnetic field-sensitive component and/or the web-shaped magnetic field-sensitive component, in particular completely enclose it.

Preferably, the housing has a temperature resistance of greater than or equal to 120° C., preferably a temperature resistance of greater than or equal to 150° C. and particularly preferably a temperature resistance of greater than or equal to 180° C.

A “penetration” of the housing is understood to be a free cross-section extending through the housing. The penetration can have an oval cross-section, preferably an elliptical or circular cross-section or any other cross-section, in particular a D-shaped or semi-circular cross-section. The penetration can completely penetrate the housing. In other words, a designated electrical conductor can penetrate the housing through the penetration.

The penetrations can run along parallel axes in the housing. Preferably, the penetrations can pass through the housing in the direction of longitudinal extension direction.

Advantageously, the axis of the through-hole of the first magnetic field-sensitive component can run coaxially with the axis of the first penetration of the housing, at least in sections. This allows a designated electrical conductor to be guided through the through-opening of the first magnetic field-sensitive component and through the first penetration of the housing in a further simplified manner.

According to a further embodiment of the invention, the housing can have at least a first penetration and a second penetration, which extend through the housing on both sides of the web-shaped magnetic field-sensitive component and within the through-opening of the ring-shaped magnetic field-sensitive component.

This means that an electrical conductor can be routed through a penetration and, in particular, routed around the ring-shaped magnetic field-sensitive component adjacent to the penetration. This allows interference currents to induce a magnetic flux in the ring-shaped magnetic field-sensitive component.

Advantageously, the web-shaped magnetic field-sensitive component is designed in one piece.

With a one piece design of the web-shaped magnetic field-sensitive component, interference of the magnetic flux by several adjacent components can be prevented. In principle, however, it is also conceivable that the web-shaped magnetic field-sensitive component is made up of several parts, in particular having several components extending parallel to each other, each of which preferably has a cuboid basic shape.

The web-shaped magnetic field-sensitive component can lie flat against the ring-shaped magnetic field-sensitive component at its base surface and its top surface, which preferably form two opposite end faces. Accordingly, the base surface and the top surface can be designed as flat surfaces, in particular if the web-shaped magnetic field-sensitive component lies flat against corresponding rectilinear sections of the ring-shaped magnetic field-sensitive component. Alternatively, the base surface and the top surface can also be designed as concave surfaces, which can in particular be designed as a segment of a circular cylindrical shell. Such a design is recommended if the ring-shaped magnetic field-sensitive component is circular.

Preferably, the web-shaped component has a rectangular cross-section. Preferably, the web-shaped magnetic field-sensitive component is designed in such a way that it does not have any abrupt cross-sectional transitions, in particular transverse to the longitudinal extension direction. In particular, the web-shaped magnetic field-sensitive component has only continuous cross-sectional transitions, which are preferably rounded. Particularly preferably, the web-shaped magnetic field-sensitive component has a constant cross-section transverse to the longitudinal extension direction. This enables a favorable magnetic flux through the web-shaped magnetic field-sensitive component. The web-shaped magnetic field-sensitive component can be flush with the ring-shaped magnetic field-sensitive component in the longitudinal extension direction.

The web-shaped magnetic field-sensitive component can extend transversely to the longitudinal extension direction over a width of at least 7 mm, in particular at least 9 mm, preferably at least 12 mm, and or at most 25 mm, in particular at most 18 mm, preferably at most 16 mm, particularly preferably over a width of 14 mm or 15 mm.

Such dimensions have proven to be advantageous for the attenuating properties of the magnetic field-sensitive assembly, particularly for the attenuating of differential-mode interference currents. The dimensions can be adapted to the specific application.

According to a preferred embodiment, the housing has at least two parts, in particular exactly two parts. Preferably, the housing has a housing shell and a housing cover.

One advantage of such a design is that it is easy to assemble, as the two parts of the housing can simply be joined together after the ring-shaped magnetic field-sensitive component and the web-shaped magnetic field-sensitive component have been inserted into one of the two housing parts, preferably into the housing shell.

The housing shell can comprise a base plate which covers a longitudinal end face of the ring-shaped magnetic field-sensitive component and/or the web-shaped magnetic field-sensitive component. Side walls can project from this base plate all the way around, covering at least the ring-shaped magnetic field-sensitive component, preferably its outer cylindrical surface.

Accordingly, a housing cover can comprise a cover plate which covers the longitudinal end face of the ring-shaped magnetic field-sensitive component and/or the web-shaped magnetic field-sensitive component opposite the base plate. Engagement means can be formed on the housing shell and/or the housing cover, by means of which the housing shell and the housing cover can be form-fittingly connected to one another. Specifically, the engagement means can have positioning protrusions formed on the housing cover, in particular circumferential positioning protrusions, which rest against the free ends of the side walls of the housing shell in order to position the housing cover relative to the housing shell. Preferably, the positioning protrusions lie on the outside of the free ends of the side wall of the housing shell. This allows the positioning protrusion to absorb the counterforce to the clamping force, particularly if the clamping means is formed on the side wall of the housing shell.

In addition, inner side walls can be formed on the housing shell or on the housing cover, which define the at least one penetration or surround it. On the other of the two housing elements, corresponding positioning protrusions, which are designed to be circumferential in particular, can be provided in order to support the inner side walls. Such an engagement, which is preferably realized both on the outer side walls and on the inner side walls, can achieve a high mechanical stability of the housing. Sections of the side walls can rest against the web-shaped magnetic field-sensitive component and/or the ring-shaped magnetic field-sensitive component in order to position them clearly in relation to each other.

The housing cover and the housing shell can also be held together by securing means. It is conceivable that the housing cover and the housing shell are glued together in the area of the positioning protrusions and the side walls. It is also possible that corresponding screw connections are provided between the housing cover and the housing shell. Other designs of securing means are also conceivable.

In a further embodiment of the present invention, the clamping means can be arranged inside the housing.

Accordingly, the clamping means can preferably be supported between a side wall of the housing and the outer cylinder surface.

The clamping means preferably acts on the outer cylinder surface.

This means that the ring-shaped magnetic field-sensitive component can be compressed from the outside in order to eliminate any leeway between the ring-shaped magnetic field-sensitive component and the web-shaped magnetic field-sensitive component during assembly.

The clamping means is preferably designed in such a way that opposing sides of the ring-shaped magnetic field-sensitive component are pressed towards each other and elastically deformed in order to clamp a web-shaped magnetic field-sensitive component arranged therebetween. In other words, the clamping means can be used to slightly reduce the opening width of the through-hole in order to clamp a web-shaped magnetic field-sensitive component arranged in between. This can ensure that there is no air gap between the ring-shaped component and the web-shaped component, which would minimize the effectiveness of the web-shaped magnetic field-sensitive component. The clamping means can pretension the ring-shaped magnetic field-sensitive component, in other words exert a preload force on the ring-shaped magnetic field-sensitive component. The preload force is selected in such a way that any leeway that exists between the web-shaped component and the ring-shaped component during assembly is eliminated.

According to a further embodiment, the clamping means can have a fixed geometry.

In other words, a dimensionally stable shape on a side wall of the housing or a corresponding dimensionally stable clamping element can be provided in order to clamp the web-shaped magnetic field-sensitive component in the ring-shaped magnetic field-sensitive component.

The clamping means can be designed as a component of the housing, in particular as a component of the housing shell.

For example, the clamping means can comprise a projection formed in a side wall of the housing, which presses against the outer cylinder surface from the outside. Preferably, a corresponding clamping projection is formed on the inside of two opposing side walls.

It is also possible that the clamping means is designed as a separate clamping element that is independent of the housing. Such a design has the advantage that, similar to a shim, the clamping element can be selected depending on the dimensions of the specific ring-shaped magnetic field-sensitive component in order to generate a precisely defined clamping force. In order to hold the clamping element on the housing, appropriate fastening means can be provided, which preferably have a force-fit and/or form-fit effect.

The clamping means can have a curvature that is formed transversely to the longitudinal direction.

Such a curvature or clamping protrusion reduces the notch stresses, which has a beneficial effect on the magnetic properties.

Alternatively, the clamping means can have a curvature and/or a wedge slope, which is formed in the longitudinal extension direction.

As a result, the stresses occurring during assembly of the housing can be reduced when the housing shell and the housing cover are joined together from both sides. A wedge slope can be provided on the side wall of the housing, whereby the wedge slope only extends over part of the longitudinal extension of the ring-shaped magnetic field-sensitive component. In other words, in this case the clamping means only acts on a longitudinal section of the ring-shaped magnetic field-sensitive component. This reduces the stresses that occur during assembly, which makes it easier to join the housing.

In a further embodiment, the clamping means can be an adjustable clamping means.

One advantage of such an adjustable clamping means is that the clamping force can be specifically adjusted. Due to manufacturing tolerances, the distance between the opposite sides of the ring-shaped magnetic field-sensitive component can vary. Such an adjustable clamping means can enable individual adjustment of the clamping force. For example, a clamping screw can be provided, which is held movably on the housing so that it can exert a compressive force on the ring-shaped magnetic field-sensitive component from the outside.

According to a preferred embodiment, the web-shaped magnetic field-sensitive component can have a relative permeability of greater than or equal to 10, preferably a relative permeability of greater than or equal to 50, further preferably a relative permeability of greater than or equal to 100 and particularly preferably a relative permeability of greater than or equal to 300. Usefully, the web-shaped magnetic field-sensitive component can have a relative permeability of greater than or equal to 500, preferably a relative permeability of greater than or equal to 1,000, further preferably a relative permeability of greater than or equal to 1,500 and particularly preferably a relative permeability of greater than or equal to 2,000.

The “permeability” is a measure of the magnetization of a material in an external magnetic field. The higher the permeability of a magnetic field-sensitive component, the greater the ratio between the magnetic flux density in the magnetic field-sensitive component and the magnetic field strength of the field acting on the magnetic field-sensitive component. Thus, a magnetic field-sensitive component with a high permeability results in a comparatively high magnetic flux density in the magnetic field-sensitive component, even at a low magnetic field strength.

The relative permeability values described above can be used to influence a designated magnetic flux through the web-shaped magnetic field-sensitive component within an advantageous range.

This allows the magnetic field-sensitive assembly used for an inductive component to be optimized not only for attenuation of common-mode interference currents (due to the material properties of the ring-shaped component) but also for attenuation of differential-mode interference currents (due to the material properties of the web-shaped component). Usually, the attenuation of common-mode interference currents and the attenuation of differential-mode interference currents is achieved by separate inductive components, so that the inductive component proposed here can achieve overall functional integration.

Optionally, the web-shaped magnetic field-sensitive component can have a relative permeability of less than or equal to 5,000, preferably a relative permeability of less than or equal to 3,500, further preferably a relative permeability of less than or equal to 2,000 and particularly preferably a relative permeability of less than or equal to 1,500.

Preferably, the web-shaped magnetic field-sensitive component can have a relative permeability of less than or equal to 1,000, preferably a relative permeability of less than or equal to 500, further preferably a relative permeability of less than or equal to 300 and particularly preferably a relative permeability of less than or equal to 100.

The web-shaped magnetic field-sensitive component can have a coercive field strength of greater than or equal to 12 A/m, preferably greater than or equal to 120 A/m and particularly preferably greater than or equal to 1,200 A/m.

Such coercive field strengths support the attenuating of differential-mode interference currents. The term “coercive field strength” refers to the magnetic field strength required to completely demagnetize a magnetic field-sensitive component that has previously been charged to saturation flux density.

According to a preferred embodiment of the invention, the web-shaped magnetic field-sensitive component is made of a soft magnetic material, in particular sintered therefrom.

The term “soft magnetic material” refers to a material that can be easily magnetized in a magnetic field. Preferably, a soft magnetic material has a coercive field strength of less than or equal to 1,000 A/m.

Preferably, a soft magnetic material, in particular an amorphous soft magnetic material, preferably a metallic glass, has an alloy comprising iron, nickel and/or cobalt.

A “metallic glass” is understood to be a metal-based alloy of a substance that has an amorphous rather than a crystalline structure at the atomic level and still has metallic conductivity as a property. Preferably, a metallic glass can also have nonmetallic alloy components in addition to metallic alloy components.

The amorphous atomic arrangement, which is very unusual for metals, enables special physical material properties. In particular, the use of metallic glasses can advantageously reduce the coercive field strength of the magnetic field-sensitive components and/or advantageously increase the permeability.

Preferably, a soft magnetic material can have the following atomic composition:

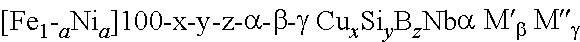

with a≤0.3, 0.6≤x≤1.5, 10≤y≤17, 5≤z≤14, 2≤α≤6, β≤7, γ≤8, where M′ is at least one of the elements V, Cr, Co, Al and Zn, where M″ is at least one of the elements C, Ge, P, Ga, Sb, In and Be.

Furthermore, a soft magnetic material may preferably comprise 73.5% by weight of iron and/or 1% by weight of copper and/or 3% by weight of niobium and/or 13.5% by weight of silicon and/or 9% by weight of boron. Conveniently, a soft magnetic material may comprise 74.5% by weight of iron and copper, with the copper content being less than or equal to 1% by weight.

In a further embodiment, the web-shaped magnetic field-sensitive component can be at least partially polished on the base surface and/or on the top surface and/or the ring-shaped magnetic field-sensitive component can be at least partially polished on the inner cylindrical surface. In particular, the corresponding surfaces can have a roughness Rₐ of less than or equal to 1.6 μm, preferably a roughness Rₐ of less than or equal to 0.8 μm and particularly preferably a roughness Rₐ of less than or equal to 0.4 μm.

“Roughness” refers to the unevenness of the surface height. There are different calculation methods for the quantitative characterization of roughness, each of which takes into account different characteristics of the surface. The “roughness Rₐ” or center roughness indicates the average distance of a measuring point on the surface to the center line.

Unevenness in the surface, for example notches, leads to disturbances in the magnetic flux. Due to the low roughness of the base surface and/or the top surface of the web-shaped magnetic field-sensitive component and/or on the inner cylindrical surface of the ring-shaped magnetic field-sensitive component, a detrimental influence on the magnetic flux caused by the roughness of these surfaces can be reduced. Accordingly, the reproducibility of the properties of the magnetic field-sensitive assembly can be improved.

Conveniently, the ring-shaped magnetic field-sensitive component can have a relative permeability of greater than or equal to 1,000, preferably a relative permeability of greater than or equal to 5,000, further preferably a relative permeability of greater than or equal to 10,000 and particularly preferably a relative permeability of greater than or equal to 20,000.

Furthermore, the ring-shaped magnetic field-sensitive component can advantageously have a relative permeability of greater than or equal to 30,000, preferably a relative permeability of greater than or equal to 45,000, further preferably a relative permeability of greater than or equal to 60,000 and particularly preferably a relative permeability of greater than or equal to 75,000.

The values of the relative permeability proposed above for the ring-shaped magnetic field-sensitive component can be used to improve the compensation of high-frequency common-mode interference currents induced on the load side or mains side.

According to an optional embodiment, the ring-shaped magnetic field-sensitive component can have a relative permeability of less than or equal to 150,000, preferably a relative permeability of less than or equal to 100,000, further preferably a relative permeability of less than or equal to 90,000 and particularly preferably a relative permeability of less than or equal to 75,000. Furthermore, the ring-shaped magnetic field-sensitive component can advantageously have a relative permeability of less than or equal to 60,000, preferably a relative permeability of less than or equal to 45,000, further preferably a relative permeability of less than or equal to 30,000 and particularly preferably a relative permeability of less than or equal to 20,000. The permeability is preferably measured in a magnetic field oscillating at 50 Hz.

Advantageously, the ring-shaped magnetic field-sensitive component can have a magnetic saturation flux density of greater than or equal to 1 T, preferably greater than or equal to 1.2 T and particularly preferably greater than or equal to 1.4 T. This means that when the magnetic field-sensitive assembly is used as an inductive component, even with comparatively large interference currents, it is possible to ensure that the ring-shaped magnetic field-sensitive component is not transferred to a saturation state.

The “saturation flux density” is a measure of the maximum extent to which a material can be magnetized by an applied magnetic field. The flux density initially increases continuously as the field strength increases. From a certain value, this effect is greatly reduced, so that a further increase in field strength only leads to a very small increase in flux density in the material. The flux density at which this flattening takes place is referred to as the saturation flux density.

Advantageously, the ring-shaped magnetic field-sensitive component can have a coercive field strength of less than or equal to 10 A/m, preferably a coercive field strength of less than or equal to 5 A/m and particularly preferably a coercive field strength of less than or equal to 3 A/m. This results in reduced heat loss due to an alternating magnetic field in the ring-shaped magnetic field-sensitive component. In this way, the ring-shaped magnetic field-sensitive component can be dimensioned even smaller with constant common-mode interference currents, thus further increasing the power density of the magnetic field-sensitive assembly.

Preferably, the ring-shaped magnetic field-sensitive component has a soft magnetic material, in particular a metallic glass, preferably with a nanocrystalline structure.

The ring-shaped magnetic field-sensitive component can be constructed in layers from a soft magnetic material; in particular, the magnetic field-sensitive component can be wound from a soft magnetic material. This can influence the eddy current losses of the magnetic field-sensitive component. Preferably, the eddy current losses can be specifically adjusted via those of the soft magnetic material, whereby the eddy current losses and thus the impedance of the magnetic field-sensitive component can be adjusted. In other words, the eddy current losses and the impedance can be adjusted by the strip thicknesses. The impedance of the magnetic field-sensitive component can be used to influence and/or adjust the transmission behavior of the magnetic field-sensitive component, in particular the attenuation of the magnetic field-sensitive component, in relation to high-frequency currents. This can be used to ensure that high-frequency currents, in particular high-frequency interference currents, are partially or completely dissipated by the magnetic field-sensitive component.

The ring-shaped magnetic field-sensitive component can in particular be wound circumferentially from a strip. The tape thickness can be at least 5 μm, in particular at least 10 μm, preferably at least 15 μm, and/or at most 200 μm, in particular at most 100 μm, preferably at most 25 μm. The tape thickness is particularly preferably 20 μm.

The total number of windings can be at least 100, in particular at least 250, preferably at least 400, and/or at most 1,500, in particular at most 1,000, preferably at most 600. Particularly preferably, the ring-shaped magnetic field-sensitive component comprises 500 windings.

Such a wound ring-shaped magnetic field-sensitive component leads to relatively high manufacturing tolerances, particularly with regard to the opening width of the through-hole, which can be compensated for accordingly by the clamping means.

Advantageously, a relative permeability of the ring-shaped magnetic field-sensitive component can be greater by a factor of greater than or equal to 1.1 than a relative permeability of the web-shaped magnetic field-sensitive component, in particular by a factor of greater than or equal to 10, preferably by a factor of greater than or equal to 100 and particularly preferably by a factor of greater than or equal to 1,000.

A magnetic field-sensitive assembly designed in this way can react particularly quickly to high-frequency alternating currents and thus compensate for load-side and/or mains-side induced interference currents even better.

On the magnetic field-sensitive assembly, in particular with regard to the web-shaped magnetic field-sensitive component, the permeability can be specified or set in a more user-specific and thus even more individualized manner if the web-shaped magnetic field-sensitive component and the ring-shaped magnetic field-sensitive component are arranged at a distance from one another, with a gap, in particular an air gap, being arranged on a head side of the web-shaped magnetic field-sensitive component opposite the ring-shaped magnetic field-sensitive component.

A head side is to be understood as any side of the web-shaped magnetic field-sensitive component which is arranged inside the ring-shaped magnetic field-sensitive component and corresponding to an inner lateral surface of the ring-shaped magnetic field-sensitive component when the web-shaped magnetic field-sensitive component is arranged in a designated manner.

In the present case, a gap is to be understood as a distance between the web-shaped magnetic field-sensitive component and the ring-shaped magnetic field-sensitive component. This gap can be filled with the ambient air or by a deviating medium filling the gap, in particular by a solid body which, in the function of a spacer element on the inside of the ring-shaped magnetic field-sensitive component, distances it from the web-shaped magnetic field-sensitive component. In this way, the permeability of the gap can be adapted, in particular the gap can have the permeability of air and/or the permeability of the spacer element. In comparison to the web-shaped magnetic field-sensitive component and/or the ring-shaped magnetic field-sensitive component, low permeability materials, in particular air, are essentially considered here.

Preferably, a gap may comprise a magnetic powder, in particular a magnetic powder dispersed in a plastic or other suitable material.

This allows the effective permeability of the magnetic short circuit of the ring-shaped magnetic field-sensitive component caused by the web-shaped magnetic field-sensitive component to be varied and/or adapted to individual designated operating conditions for the magnetic field-sensitive assembly proposed here. This makes it possible, among other things, to adjust the filtering of common-mode interference currents and/or differential-mode interference currents.

It is understood that the magnetic field-sensitive assembly proposed here can also have a gap between the web-shaped magnetic field-sensitive component and the ring-shaped magnetic field-sensitive component on both sides of the web-shaped magnetic field-sensitive component and/or on all head sides of the web-shaped magnetic field-sensitive component within the ring-shaped magnetic field-sensitive component, in particular on two or three or more head sides. It should also be borne in mind that the corresponding gaps can be filled with different media and/or materials.

Advantageously, a gap can be filled with a solid which fixes the web-shaped magnetic field-sensitive component in the ring-shaped magnetic field-sensitive component, in particular a hardened adhesive.

According to a second aspect of the invention, the problem is solved by an inductive component comprising a magnetic field-sensitive assembly according to the first aspect of the invention, wherein the housing has at least a first penetration and a second penetration, which extend through the housing on both sides of the web-shaped magnetic field-sensitive component and within the through-opening of the ring-shaped magnetic field-sensitive component, a first conductor and a second conductor;
wherein the first conductor is passed at least once through the first penetration; and
with the second conductor is passed at least once through the second penetration.

It will be understood that the advantages of a magnetic field sensitive assembly according to the first aspect of the invention, as described above, extend directly to an inductive component comprising a magnetic field sensitive assembly according to the first aspect of the invention.

The first conductor and/or the second conductor can be designed as a busbar.

It should be expressly noted that the subject matter of the second aspect can be advantageously combined with the subject matter of the preceding aspect of the invention, both individually or cumulatively in any combination.

According to a third aspect of the invention, the problem is solved by a method for manufacturing a magnetic field-sensitive assembly as described above, comprising the following steps:
providing a ring-shaped magnetic field-sensitive component;
providing a web-shaped magnetic field sensitive component; and
clamping of the web-shaped magnetic field-sensitive component within the ring-shaped magnetic field-sensitive component using a clamping means.

It should be expressly noted that the subject matter of the third aspect can be advantageously combined with the subject matter of the preceding aspects of the invention, either individually or cumulatively in any combination.

According to a fourth aspect of the invention, the task is solved by using a magnetic field-sensitive assembly according to the first aspect of the invention as an inductive component, in particular for reducing common-mode interference and/or differential-mode interference.

It will be understood that the advantages of a magnetic field sensitive assembly according to the first aspect of the invention, as described above, extend directly to a use of a magnetic field sensitive assembly according to the first aspect of the invention as an inductive component.

Advantageously, a magnetic field-sensitive assembly can be used as an inductive component in a power supply system, preferably in a DC power supply system and particularly preferably in a DC power supply system for supplying power to a battery-electric storage system.

A power supply system can be designed as a charger, in particular as a charger for a vehicle having a battery-electric storage unit, preferably for a battery-electric vehicle (BEV), but again preferably for a battery-electric commercial vehicle.

Alternatively, a power supply system, in particular a DC power supply system, can be designed to supply an electrical load with power, in particular an electric drive unit, preferably an electric motor, in particular an electric motor of a vehicle.

A power supply system can have at least one frequency converter.

It should be expressly noted that the subject matter of the fourth aspect can be advantageously combined with the subject matter of the preceding aspects of the invention, either individually or cumulatively in any combination.

Further advantages, details and features of the invention are shown in the following embodiments. These show in detail:

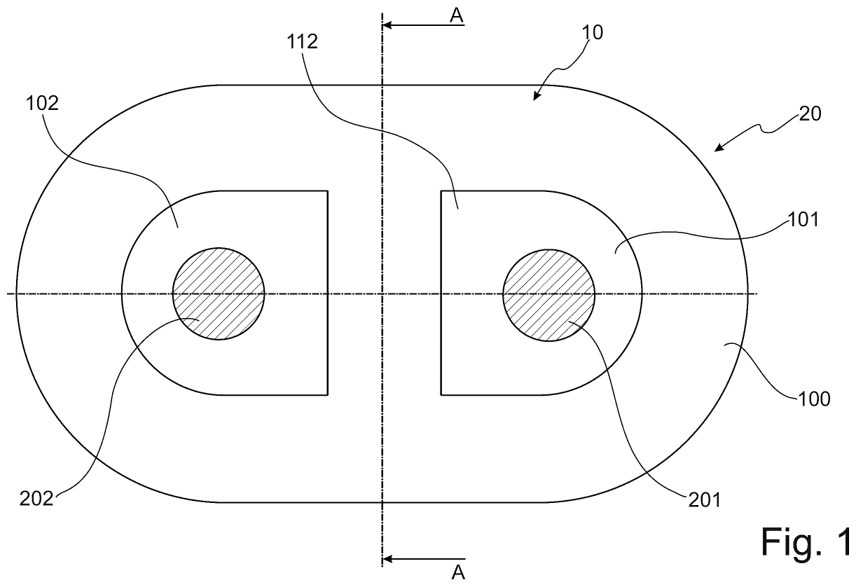

FIG. 1A top view of an inductive component with a magnetic field-sensitive assembly according to the present invention;

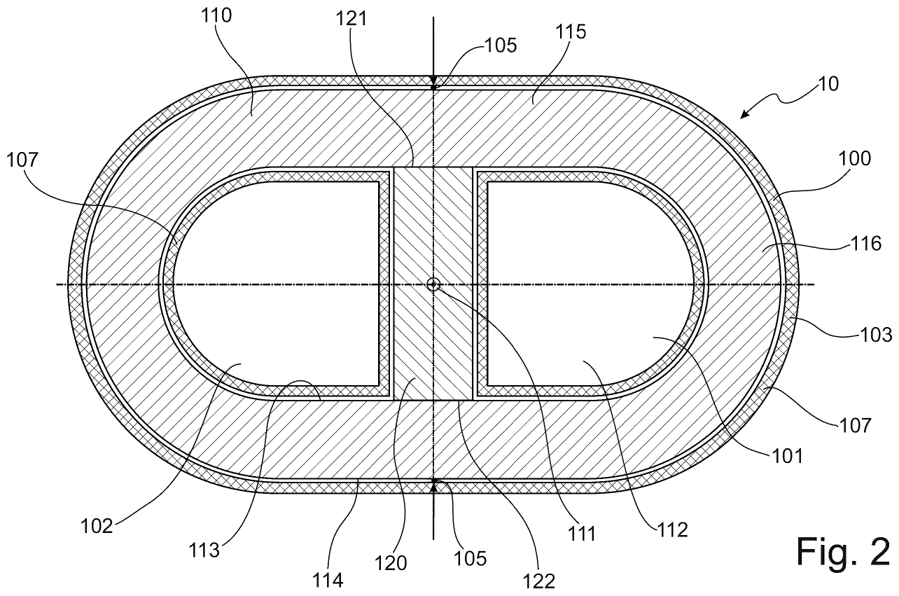

FIG. 2A longitudinal sectional view of the magnetic field-sensitive assembly from FIG. 1, with the clamping means shown only schematically;

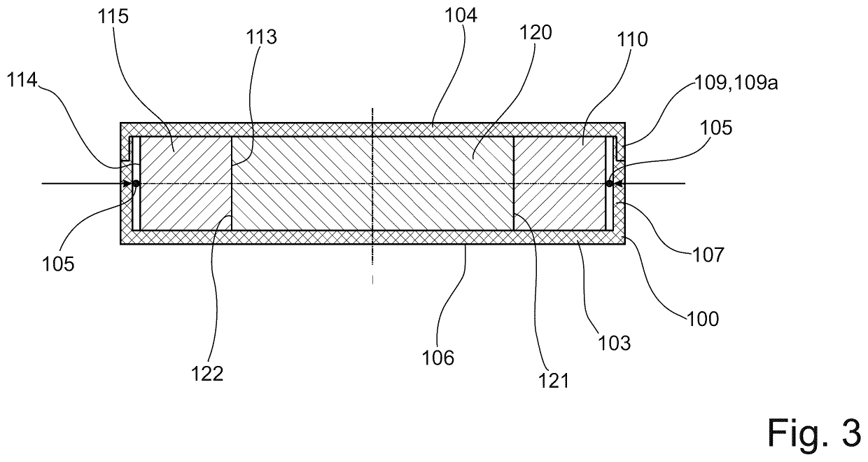

FIG. 3 the magnetic field-sensitive assembly from FIG. 1 in a sectional view along the sectional lines A-A, whereby the clamping means is only shown schematically;

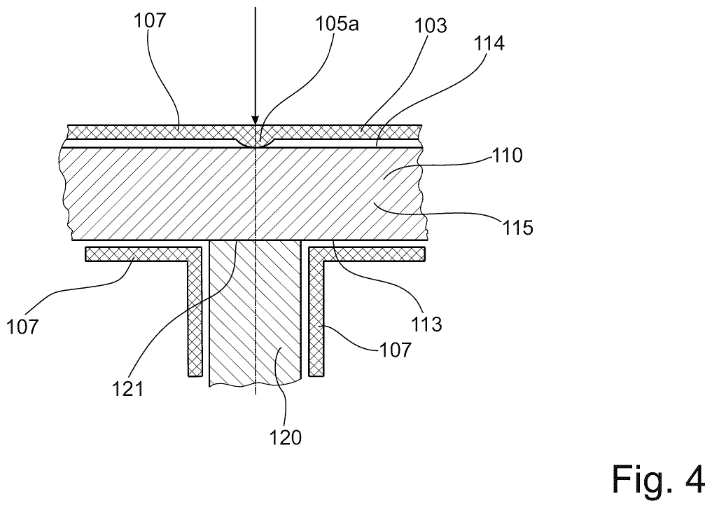

FIG. 4A detailed sectional view of the assembly from FIG. 1 with a first embodiment of a clamping means;

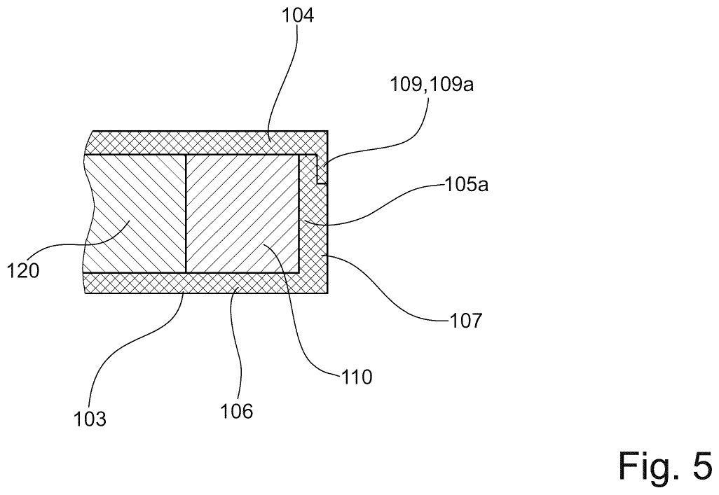

FIG. 5 Another sectional view of the magnetic field-sensitive assembly from FIG. 4 along section line A-A;

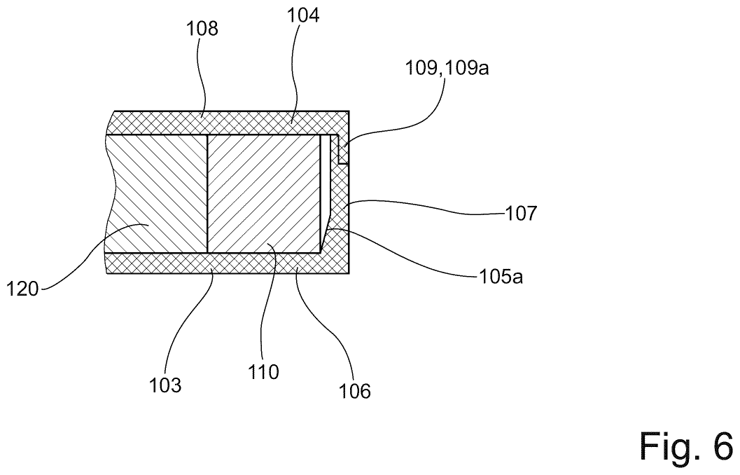

FIG. 6 the assembly from FIG. 1 with a second embodiment of a clamping means in a sectional view along the sectional line A-A;

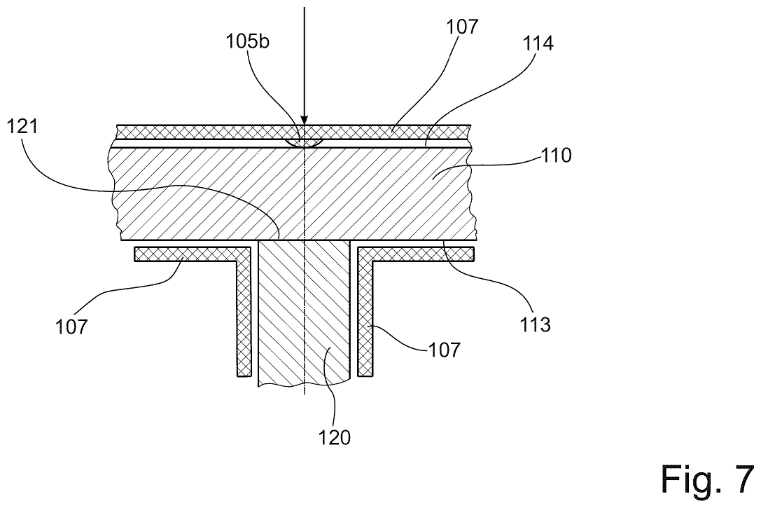

FIG. 7 the assembly of FIG. 1 with a third embodiment of a clamping means in a cross-sectional view; and

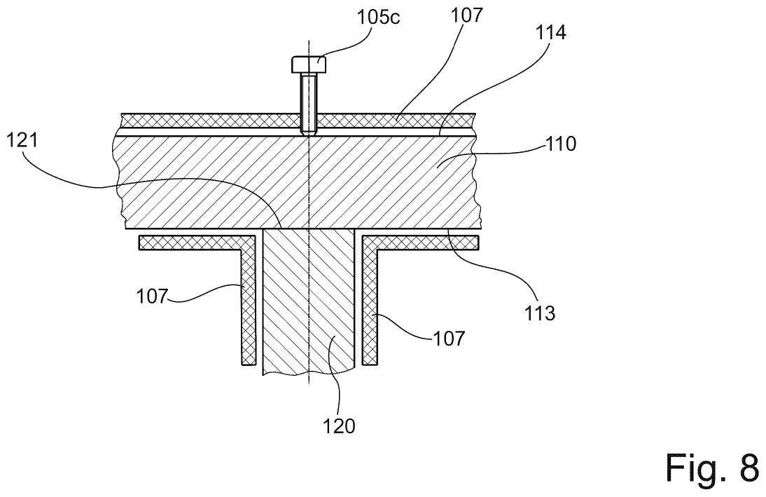

FIG. 8 Cross-sectional view of the assembly from FIG. 1 with a fourth embodiment of a clamping means.

In the following description, the same reference signs denote the same components or the same features, so that a description carried out in relation to one figure with regard to a component also applies to the other figures, so that a repetitive description is avoided. Furthermore, individual features described in connection with one embodiment can also be used separately in other embodiments.

FIG. 1 shows an inductive component 20 according to the present invention. This comprises a magnetic field-sensitive assembly 10, which has a housing 100 with a first penetration 101 and a second penetration 102. Both penetrations 101, 102 are D-shaped. A first conductor 201 passes through the first penetration 101 and a second conductor 202 passes through the second penetration 102.

The basic structure of a magnetic field-sensitive assembly 10 according to the present invention is shown in FIGS. 2 and 3.

The magnetic field-sensitive assembly 10 has an ring-shaped magnetic field-sensitive component 110, which has a longitudinal extension direction 111 and a centrally arranged through-opening 112 extending in the longitudinal extension direction 111, which in the present case is formed in cross-section as an oval with two axes of symmetry. Specifically, the ring-shaped magnetic field-sensitive component 110 comprises two opposing rectilinear sections 115, which extend parallel to one another and are connected to one another by semicircular arcs 116. Over its entire circumference, the ring-shaped magnetic field-sensitive component 110 has a constant square cross-section.

Accordingly, the ring-shaped magnetic field-sensitive component 110 has an inner cylindrical surface 113 and an outer cylindrical surface 114. The inner cylindrical surface 113 is polished and has a roughness Rₐ of approximately 0.4 μm.

In the present case, the ring-shaped magnetic field-sensitive component 110 consists of a soft magnetic material in the form of metallic glass, which is wound around a strip. The strip thickness is approximately 20 μm and the ring-shaped magnetic field-sensitive component comprises a total of 500 windings. The soft magnetic material has a relative permeability of more than 30,000 and a coercive field strength of less than 3 A/m.

The magnetic field-sensitive assembly 10 further comprises a cuboid, web-shaped magnetic field-sensitive component 120, which is formed in one piece and has a flat base surface 121 and a flat top surface 122, which in the present case form two opposing end faces. The base surface 121 and the top surface 122 are flat and polished in such a way that the roughness Rₐ is approximately 0.4 μm.

The web-shaped component 120 is arranged within the through-opening 112 of the ring-shaped magnetic field-sensitive component 110, wherein the base surface 121 and the top surface 122 each lie flat against the inner cylindrical surface 113 of the ring-shaped magnetic field-sensitive component 110. In the longitudinal extension direction, the web-shaped magnetic field-sensitive component 120 is flush on both sides with the longitudinal end faces of the ring-shaped magnetic field-sensitive component 110.

The web-shaped magnetic field-sensitive component 120 is sintered from a soft magnetic material. This soft magnetic material has a coercive field strength of approximately 1,200 A/m and a relative permeability of less than 100.

The ring-shaped magnetic field-sensitive component 110 and the web-shaped magnetic field-sensitive component 120 are completely enclosed by a housing 100 made of a plastic. The plastic is selected so that it has a temperature resistance of more than 180° C.

Specifically, the housing 100 comprises a housing shell 103 and a housing cover 104, which are connected to each other.

The housing shell 103 has a base plate 106, which covers a longitudinal end face of the ring-shaped magnetic field-sensitive component 110 and the web-shaped magnetic field-sensitive component 120. Circumferential side walls 107 project from this base plate 106 and cover the ring-shaped magnetic field-sensitive component 110, specifically its outer cylindrical surface 114. Inner side walls 107, which each define a penetration 101, 102, project from the base plate 106 and cover the inner cylindrical surface 113 and the side surface of the web-shaped magnetic field-sensitive component 110 the respective penetration 101, 102.

The housing cover 104 comprises a cover plate 108, which covers the longitudinal end face of the ring-shaped magnetic field-sensitive component 110 and the web-shaped magnetic field-sensitive component 120 opposite the base plate 106. Engagement means are formed on the housing shell 103 and the housing cover 104, via which the housing shell 103 and the housing cover 104 are form-fittingly engaged with one another. The engagement means comprise circumferential 1 positioning protrusions 109 formed on the housing cover 104, which bear against the free ends of the side walls 107 of the housing shell 103 in order to position the housing cover 104 relative to the housing shell 103. In this case, the positioning protrusions 109 rest against the free ends of the side walls 107 of the housing shell 103 from the outside. Specifically, a positioning recess 109a corresponding to the positioning protrusion 109 is provided at the free ends of the side walls 107 for this purpose, so that the side walls 107 are tapered at their free ends.

FIG. 2 shows that a small gap is formed all around between the side walls 107 and the ring-shaped magnetic field-sensitive component 110 or the web-shaped magnetic field-sensitive component 120. It is also conceivable that such a gap is missing, in particular between the inner side walls 107 and the web-shaped magnetic field-sensitive component 120, i.e. the side walls 107 rest against the web-shaped magnetic field-sensitive component 120 in order to clearly position the web-shaped magnetic field-sensitive component 120 relative to the ring-shaped magnetic field-sensitive component 110.

In addition, the magnetic field-sensitive assembly 10 has at least one clamping means 105, which is only shown schematically in FIGS. 2 and 3 with regard to its function with the arrows. The clamping means 105 is designed to clamp the web-shaped magnetic field-sensitive component 120 within the ring-shaped magnetic field-sensitive component 110. In the present case, the clamping means 105 acts on the outer cylindrical surface 114 of the ring-shaped magnetic field-sensitive component 110. In other words, the clamping means 105 applies a clamping force to the outer cylindrical surface 114 from the outside, so that the ring-shaped magnetic field-sensitive component 110, in particular its rectilinear sections 115, are compressed from the outside in order to clamp the web-shaped magnetic field-sensitive component 120 arranged within the through-opening 112. In other words, the ring-shaped magnetic field-sensitive component 110 is elastically deformed.

The clamping means 105 and the clamping force generated by it ensure that the base surface 121 and the top surface 122 of the web-shaped magnetic field-sensitive component 120 lie flat against the inner cylindrical surface 113 of the ring-shaped magnetic field-sensitive component 110.

Various exemplary embodiments of the clamping means 105 are shown in detail in FIGS. 4 to 8.

A first embodiment is shown in FIGS. 4 and 5. Here, a corresponding clamping projection 105a is formed in the side wall 107 of the housing shell 103, which presses on the outside against the ring-shaped magnetic field-sensitive component 110 and thus elastically deforms the latter inwards in order to clamp the web-shaped magnetic field-sensitive component 120 between opposing sections of the inner cylindrical surface 113.

The clamping projection 105a extends over the entire length of the ring-shaped magnetic field-sensitive component 110. During assembly, it is necessary to manually exert a preload force on the side wall 107 of the housing 100 before the housing cover 104 is placed on the housing shell 103 and the positioning protrusion 109 engages around the side wall 107 from the outside.

FIG. 6 shows an alternative design of the clamping means 105. Here, a clamping projection 105a is also formed on the side wall 107 of the housing shell 103. However, this does not extend continuously over the entire length of the ring-shaped magnetic field-sensitive component 110, but is wedge-shaped, so that it only acts on the ring-shaped magnetic field-sensitive component 110 at one longitudinal end region. Such a configuration facilitates assembly, since the ring-shaped magnetic field-sensitive component 110 can initially be inserted into the housing shell 103 without force resistance and only at the end of this insertion is a clamping force exerted on the ring-shaped magnetic field-sensitive component 110 by the wedge-shaped clamping projection 105a.

FIG. 7 shows a further possible embodiment of a clamping means 105. In contrast to the two previous embodiments, the clamping means 105 is not formed as a component of the housing 100, but as a separate clamping element 105b. Such an embodiment has the advantage that, similar to a shim, the clamping element 105b can be selected depending on the dimensions present in the respective specific ring-shaped magnetic field-sensitive component 110 in order to generate a precisely defined clamping force. In order to hold the clamping element 105b on the housing 100, corresponding fastening means can be provided, which preferably have a force-fit and/or form-fit effect.

FIG. 8 shows a further embodiment of a clamping means 105. Here, the clamping means 105 is designed to be adjustable so that a defined force can be applied to the ring-shaped magnetic field-sensitive component 110 from the outside. Specifically, a clamping screw 105c is provided here, which is held adjustably on the housing 100, in this case on the side wall 107. Corresponding metallic threaded inserts, not shown in FIG. 8, can be provided on the housing 100 for this purpose. By contacting the front end face of the clamping screw 105c with the outer cylindrical surface 114 of the ring-shaped magnetic field-sensitive component 110, a defined clamping force can be applied in order to clamp the web-shaped magnetic field-sensitive component 120.

The embodiments of clamping means shown in FIGS. 4 to 8 can comprise a clamping means 105 as a whole or can each comprise a clamping means 105 on opposite sides. The clamping means 105 explained above can also be combined with one another as desired. Other clamping means 105, not presented in detail, are also conceivable.

By clamping the web-shaped magnetic field-sensitive component 120 within the ring-shaped magnetic field-sensitive component 110, an air gap between these components is prevented. This has a positive effect on the properties of the magnetic field-sensitive assembly 10.

Due to the fact that the web-shaped magnetic field-sensitive component 120 has a significantly lower permeability but a significantly higher coercive field strength than the ring-shaped magnetic field-sensitive component 110, the magnetic field-sensitive assembly 10 is suitable for efficiently attenuating or filtering out both common-mode interference currents and differential-mode interference currents in the two conductors 201, 202.

### LIST OF REFERENCE NUMERALS

10 Magnetic field sensitive assembly
20 Inductive component
100 Housing
101 First penetration
102 Second penetration
103 Housing shell
104 Housing cover
105 Clamping means
105a Clamping projection
105b Clamping element
105c Clamping screw
106 Base plate
107 Side wall
108 Cover plate
109 Positioning protrusion
109a Positioning recess
110 Ring-shaped magnetic field-sensitive component
111 Longitudinal extension direction of the ring-shaped magnetic field-sensitive component
112 Through-opening of the ring-shaped magnetic field-sensitive component
113 Inner cylindrical surface
114 Outer cylindrical surface
115 Straight section
116 Semicircular arch
120 Web-shaped magnetic field-sensitive component
121 Base surface
122 Top surface
201 First conductor
202 Second conductor

1. A magnetic field sensitive assembly, comprising:
a ring-shaped magnetic field-sensitive component and at least one web-shaped magnetic field-sensitive component accommodated in a housing;
wherein the ring-shaped magnetic field-sensitive component comprises a longitudinal extension direction and a centrally arranged through-opening extending in the longitudinal extension direction, wherein the through-opening is formed in cross-section as an oval with two axes of symmetry;
wherein the ring-shaped magnetic field-sensitive component comprises an inner cylindrical surface and an outer cylindrical surface;
wherein the web-shaped magnetic field-sensitive component is cuboidal, comprising a base surface and a top surface and is arranged within the through-opening, wherein the base surface and the top surface are arranged in correspondence with the inner cylindrical surface;
wherein the housing comprises at least a first penetration extending through the housing within the through-opening of the ring-shaped magnetic field sensitive component; and
wherein the magnetic field-sensitive assembly further comprises at least one clamping means which is adapted to clamp the web-shaped magnetic field-sensitive component within the ring-shaped magnetic field-sensitive component.

2. The magnetic field-sensitive assembly according to claim 1, wherein the housing comprises at least a first penetration and a second penetration, which extend through the housing on both sides of the web-shaped magnetic field-sensitive component and within the through-opening of the ring-shaped magnetic field-sensitive component.

3. The magnetic field-sensitive assembly according to claim 1, wherein the web-shaped magnetic field-sensitive component is formed in one piece.

4. The magnetic field-sensitive assembly according to claim 1, wherein the housing comprises at least two parts, a housing shell and a housing cover.

5. The magnetic field-sensitive assembly according to claim 1, wherein the clamping means is arranged inside the housing.

6. The magnetic field-sensitive assembly according to claim 1, wherein the clamping means acts on the outer cylindrical surface.

7. The magnetic field-sensitive assembly according to claim 1, wherein the clamping means has a fixed geometry.

8. The magnetic field-sensitive assembly according to claim 1, wherein the clamping means is a component of the housing.

9. The magnetic field-sensitive assembly according to claim 1, wherein the clamping means comprises a curvature which is formed transversely from the longitudinal direction of extension.

10. The magnetic field-sensitive assembly according to claim 1, wherein the clamping means comprises a curvature and/or a wedge slope, which is formed in the longitudinal direction of extension.

11. The magnetic field-sensitive assembly according to claim 1, wherein the clamping means is an adjustable clamping means.

12. The magnetic field-sensitive assembly according to claim 1, wherein the web-shaped magnetic field-sensitive component comprises a relative permeability of greater than or equal to 10.

13. The magnetic field-sensitive assembly according to claim 1, wherein the web-shaped magnetic field-sensitive component comprises a relative permeability of less than or equal to 5,000.

14. The magnetic field-sensitive assembly according to claim 1, wherein the web-shaped magnetic field-sensitive component comprises a coercive field strength of greater than or equal to 12 A/m.

15. The magnetic field-sensitive assembly according to claim 1, wherein the web-shaped magnetic field-sensitive component is made of a soft magnetic material.

16. The magnetic field-sensitive assembly according to claim 1, wherein the web-shaped magnetic field-sensitive component is at least partially polished on the base surface, and/or on the top surface, and/or the ring-shaped magnetic field-sensitive component is at least partially polished on the inner cylindrical surface, with a roughness Rₐ of less than or equal to 1.6 μm.

17. The magnetic field-sensitive assembly according to claim 1, wherein the ring-shaped magnetic field-sensitive component comprises a relative permeability of greater than or equal to 1,000.

18. The magnetic field-sensitive assembly according to claim 1, wherein the ring-shaped magnetic field-sensitive component comprises a soft magnetic material.

19. The magnetic field-sensitive assembly according to claim 1, wherein a relative permeability of the ring-shaped magnetic field-sensitive component is greater by a factor of greater than or equal to 1.1 than a relative permeability of the web-shaped magnetic field-sensitive component.

20. An inductive component comprising:
a magnetic field-sensitive assembly according to claim 2, a first conductor and a second conductor;
wherein the first conductor is passed at least once through the first penetration; and
wherein the second conductor is passed at least once through the second penetration.

21. A method of manufacturing the magnetic field sensitive assembly according to claim 1, the method comprising:
providing a ring-shaped magnetic field-sensitive component;
providing a web-shaped magnetic field sensitive component; and
clamping the web-shaped magnetic field-sensitive component within the ring-shaped magnetic field-sensitive component using a clamping means.

22. (canceled)
